(19) United States
(12) Patent Application Publication
(10) Pub. No.: US 2025/0311020 A1
(43) Pub. Date: Oct. 2, 2025

(54) FIRST COMMUNICATION DEVICE, NON-TRANSITORY COMPUTER-READABLE RECORDING MEDIUM STORING COMPUTER-READABLE INSTRUCTIONS FOR FIRST COMMUNICATION DEVICE, AND METHOD EXECUTED BY FIRST COMMUNICATION DEVICE

(71) Applicant: BROTHER KOGYO KABUSHIKI KAISHA, Nagoya (JP)

(72) Inventor: Ryoya TSUJI, Nagoya (JP)

(21) Appl. No.: 19/088,459

(22) Filed: Mar. 24, 2025

(30) Foreign Application Priority Data
Mar. 26, 2024 (JP) 2024-049235

(51) Int. Cl. H04W 76/10; G06F 3/12; H04W 64/00; H04W 84/12

(52) U.S. Cl. CPC H04W 76/10; H04W 64/00; G06F 3/1236; G06F 3/1292; H04W 84/12

(57) ABSTRACT

A first communication device may receive a first signal from a second communication device via a Wi-Fi interface and send a second signal to the second communication device via the Wi-Fi interface, specify a first target distance calculated based on communication of the first signal and the second signal, and in a case where the first target distance is equal to or less than a predetermined distance, execute a predetermined process related to communication of predetermined data between the first communication device and the second communication device. In a case where the first target distance is not equal to or less than the predetermined distance, the predetermined process is not executed. The predetermined distance is shorter than a distance in which the first communication device can communicate with the second communication device via the Wi-Fi interface.

### REFERENCE TO RELATED APPLICATIONS

This application claims priority from Japanese Patent Application No. 2024-049235 filed on Mar. 26, 2024. The entire content of the priority application is incorporated herein by reference.

### BACKGROUND ART

A mobile terminal is known that measures a distance between the mobile terminal and a multi-function peripheral (MFP) based on a radio wave strength of a Bluetooth Beacon signal when the mobile terminal receives the Bluetooth Beacon signal from the MFP. Bluetooth is a registered trademark of Bluetooth SIG. When the distance is less than a threshold value, the mobile terminal displays a print data selection screen and sends a print executing instruction notification to the MFP. When the distance is greater than the threshold value, the mobile terminal displays a warning notification screen.

### SUMMARY

The preset teachings provide an art configured to enable a communication device to switch whether or not to execute a given process depending on a distance calculated using a different method than conventional methods.

A first communication device disclosed herein may include: a Wi-Fi interface configured for Wi-Fi communication according to a Wi-Fi standard; and a controller, wherein the controller may be configured to: receive a first signal from a second communication device via the Wi-Fi interface and send a second signal to the second communication device via the Wi-Fi interface; specify a first target distance between the first communication device and the second communication device, the first target distance being calculated based on communication of the first signal and the second signal; in a case where the first target distance is equal to or less than a predetermined distance, execute a predetermined process related to communication of predetermined data between the first communication device and the second communication device, wherein in a case where the first target distance is not equal to or less than the predetermined distance, the predetermined process is not executed, and the predetermined distance is shorter than a distance in which the first communication device can communicate with the second communication device via the Wi-Fi interface.

According to the above configuration, the first communication device specifies the first target distance calculated based on the communication of the first and second signals via the Wi-Fi interface, executes the predetermined process in the case where the first target distance is equal to or less than the predetermined distance, and does not execute the predetermined process in the case where the first target distance is not equal to or less than the predetermined distance. Thus, the first communication device can switch whether or not to execute the predetermined process depending on the distance calculated using a different method than the conventional methods.

Computer-readable instructions for realizing the first communication device, a non-transitory computer-readable recording medium storing those computer-readable instructions, and a method executed by the first communication device are also novel and useful. A system comprising the first communication device and the second communication device is also novel and useful.

### BRIEF DESCRIPTION OF DRAWINGS

FIG. 1 shows a configuration of a communication system.

FIG. 2 shows a sequence diagram of processes executed by a mobile terminal and a printer.

FIG. 3 shows a sequence diagram of a communication process for specifying a distance.

FIG. 4 shows a sequence diagram of a second embodiment.

### DESCRIPTION

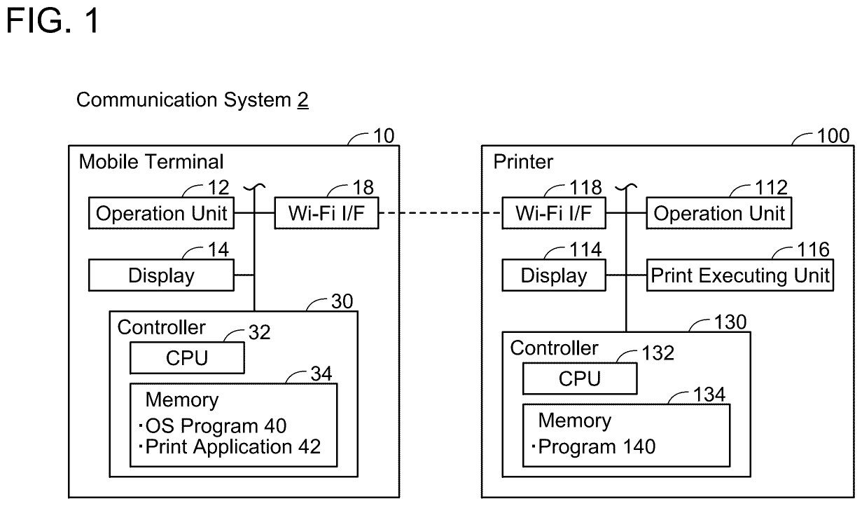

### (Overview of Communication System 2: FIG. 1)

As shown in FIG. 1, a communication system 2 comprises a mobile terminal 10 and a printer 100. The mobile terminal 10 and the printer 100 are configured to execute Wi-Fi communication according to a Wi-Fi standard. The present embodiment discloses a technique in which a user of the mobile terminal 10 uses the mobile terminal 10 to cause the printer 100 to execute printing.

### (Configuration of Mobile Terminal 10)

The mobile terminal 10 is a mobile terminal device such as a smartphone, tablet PC, or laptop PC. A stationary terminal device may be used instead of the mobile terminal 10. The mobile terminal 10 comprises an operation unit 12, a display 14, a Wi-Fi interface 18, and a controller 30. Each of the parts 12-30 is connected to a bus line.

The operation unit 12 is an I/F that allows the user to input various information to the mobile terminal 10, and comprises a touch screen and/or button(s) for example. The display 14 is a display configured to show various information.

The Wi-Fi I/F 18 is a wireless I/F for Wi-Fi communication according to Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. Especially, the Wi-Fi I/F 18 supports a Wi-Fi Aware scheme established by the Wi-Fi Alliance. Wi-Fi Aware is described in detail in the specification called “Wi-Fi Aware Specification Version 4.0” created by the Wi-Fi Alliance.

In the Wi-Fi Aware scheme, each device first joins a Neighbor Awareness Network (NAN) cluster. Among devices within the same NAN cluster, their Discovery Windows are synchronized. A Discovery Window is a period for sending and receiving signals.

The devices within the NAN cluster play any one of roles called Master, Anchor Master, and Non-Master. A Master is capable of sharing timer information, searching for services, and inviting a device to the NAN cluster. In addition to the Master's functions, an Anchor Master is also capable of setting timer information for synchronization. A Non-Master is capable of sharing timer information and searching for services but incapable of inviting a device to the cluster.

Each device within the NAN cluster can search for other devices within the NAN cluster (more specifically, services provided by the other devices). A signal for searching for a service is called ‘Subscribe’. A device that has received a Subscribe sends a response signal called ‘Publish’. In this embodiment, the mobile terminal 10 sends a Subscribe to search for other devices that can provide a short-range printing service. The short-range printing service is a service that executes printing according to print data in a case where a distance between a device from which the print data is sent and a device to which the print data is sent is equal to or less than a predetermined distance. Since the printer 100 is capable of providing the short-range printing service, when the printer 100 receives a Subscribe from the mobile terminal 10, the printer 100 sends a Publish, to the mobile terminal 10, indicating that the printer 100 is capable of providing the short-range printing service. This allows the mobile terminal 10 to find the printer 100.

The Subscribes and Publishes described above are communicated using layers that are lower than a network layer of the OSI reference model. That is, the above-described search is executed without executing communication of the network layer or higher layer of the OSI reference model. A pair of devices within the same NAN cluster is incapable of executing communication of the network layer or higher layer of the OSI reference model unless they establish a connection. In this embodiment, a state where a device simply belongs to a NAN cluster, i.e., a state where a device is incapable of executing communication of the network layer or higher layer with another device within a NAN cluster is phrased as “the device does not belong to the same Wi-Fi network to which the other device belongs”, while a state where a device is capable of executing communication of the network layer or higher layer with another device within a NAN cluster is phrased as “the device belongs to the same Wi-Fi network to which the other device belongs”.

The controller 30 comprises a CPU 32 and a memory 34. The memory 34 comprises a main storage and an auxiliary storage. The main storage includes, for example, a RAM, a cache memory, etc. The auxiliary storage may be, for example, a flash memory, a Solid State Drive (SSD), a ROM, or a combination thereof. An OS program 40 and a print application 42 are stored in the auxiliary storage. The CPU 32 implements various processes according to the programs 40, 42 loaded from the auxiliary storage to the main storage. Hereinafter, the OS program is abbreviated “OS”. The print application is abbreviated as “app”.

The OS 40 controls basic operations of the mobile terminal 10. The app 42 can establish a Wi-Fi connection between the mobile terminal 10 and the printer 100 by causing the OS 40 to execute a process according to the Wi-Fi Aware scheme. The app 42 can also use the Wi-Fi connection (i.e., the Wi-Fi network to which both the mobile terminal 10 and the printer 100 belong) to send print data representing an image to be printed to the printer 100. The app 42 is downloaded from a server on the Internet, for example, and installed on the mobile terminal 10.

### (Configuration of Printer 100)

The printer 100 is a peripheral device capable of performing a print function, e.g., a peripheral device for the mobile terminal 10. In a modification, the printer 100 may be a multifunction peripheral capable of performing a scan function, a facsimile function, and the like in addition to the print function. The printer 100 comprises an operation unit 112, a display 114, a Wi-Fi interface 118, a print executing unit 116, and a controller 130. Each of the parts 112-130 is connected to a bus line.

The operation unit 112 is an I/F through which a user can input various information to the printer 100 and comprises, for example, a touch screen and/or buttons. The display 114 is a display for displaying various information. As with the Wi-Fi I/F 18 of the mobile terminal 10, the Wi-Fi I/F 118 supports the Wi-Fi Aware scheme. The print executing unit 116 comprises a print mechanism of an inkjet scheme or a laser scheme, for example.

The controller 130 comprises a CPU 132 and a memory 134. The memory 134 comprises a main storage and an auxiliary storage. A program 140 is stored in the auxiliary storage. The CPU 132 implements various processes according to the program 140 loaded to the main storage from the auxiliary storage.

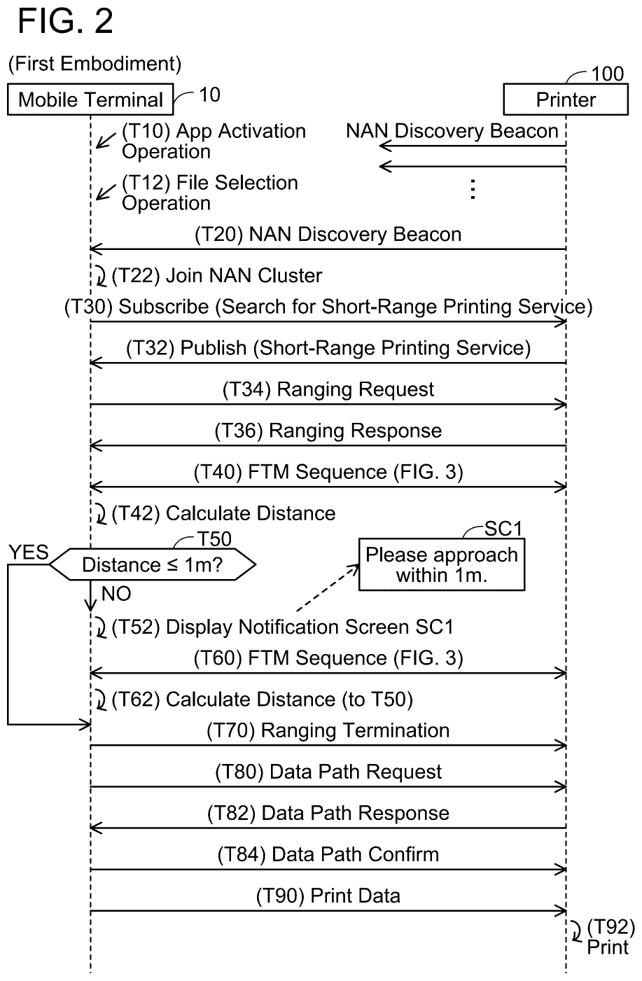

### (Process Executed by Mobile Terminal 10 and Printer 100: FIG. 2)

Referring now to FIG. 2, processes executed by the mobile terminal 10 and the printer 100 will be described. Hereinafter, in order to facilitate understanding, actions of the CPUs 32, 132 of the mobile terminal 10 and the printer 100 will be described with the device as subject of action, without describing the CPU as subject of action. Further, communication between the mobile terminal 10 and the printer 100 is executed via the Wi-Fi I/F 18, 118. Thus, a phrase “via the Wi-Fi I/F” is omitted in communication-related descriptions hereinafter.

In an initial state of FIG. 2, the printer 100 belongs to a NAN cluster and is operating as an Anchor Master of that NAN cluster. In the initial state of FIG. 2, the app 42 has not been activated yet and the mobile terminal 10 is incapable of receiving signals according to the Wi-Fi Aware scheme. Here, “the mobile terminal 10 is incapable of receiving signals according to the Wi-Fi Aware scheme” means that the Wi-Fi interface 18 does not receive signals according to the Wi-Fi Aware scheme from external device(s). In a modification, “the mobile terminal 10 is incapable of receiving signals according to the Wi-Fi Aware scheme” may mean that the Wi-Fi interface 18 receives signals according to the Wi-Fi Aware scheme from external device(s) but the CPU 32 does not execute a process according to the received signals (i.e., ignores the received signals). Hereinafter, the state of being incapable of receiving signals according to the Wi-Fi Aware scheme is termed “incapable state”.

The printer 100 sends a NAN Discovery Beacon frame (hereinafter termed “Discovery”) by broadcasting. The Discovery is a signal according to the Wi-Fi Aware scheme that advises information related to the NAN cluster to which the printer 100 belongs to external devices. Devices that do not belong to the NAN cluster can belong to the NAN cluster by receiving the Discovery. That is, the Discovery can be also construed as a signal for inviting devices that do not belong to the NAN cluster to the NAN cluster. The printer 100 periodically sends a Discovery. Since the mobile terminal 10 is in the incapable state in the initial state shown in FIG. 2, the mobile terminal 10 does not receive the Discovery from the printer 100.

In T10, the mobile terminal 10 receives an app activation operation from the user. As a result, the mobile terminal 10 activates the app 42 and executes each of the following processes according to the app 42. When the app 42 is activated, the mobile terminal 10 shifts from the incapable state to a state of being capable of receiving signals according to the Wi-Fi Aware scheme. The “state of being capable of receiving signals according to the Wi-Fi Aware scheme” means that the Wi-Fi interface 18 is capable of receiving signals according to the Wi-Fi Aware scheme from external devices and the CPU 32 is capable of executing a process according to the received signals. Hereinafter, the state of being capable of receiving signals according to the Wi-Fi Aware scheme is termed “capable state”.

In T12, the mobile terminal 10 receives a selection operation of a file representing an image to be printed. Here, the mobile terminal 10 may further receive a selection of printing condition(s) (e.g., selection of color printing or monochrome printing, selection of printing paper).

In T20, the printer 100 sends a Discovery. Since the mobile terminal 10 is in the capable state at the time of T20, the mobile terminal 10 receives the Discovery from the printer 100. The mobile terminal 10 then joins the NAN cluster in T22. As a result, the mobile terminal 10 and the printer 100 belong to the same NAN cluster. However, as mentioned above, the mobile terminal 10 is still incapable of executing communication of the network layer or higher layer of the OSI reference model with the printer 100 at this time. That is, the mobile terminal 10 does not belong to the same Wi-Fi network to which the printer 100 belongs. Once having joined the NAN cluster, the mobile terminal 10 executes communication with the printer 100 to determine its role within the NAN cluster, although not shown. In the present case, the mobile terminal 10 operates as a Non-Master.

In T30, the mobile terminal 10 sends a Subscribe to the NAN cluster by broadcasting to search for devices that provide the short-range printing service. The Subscribe is received by the printer 100 within the NAN cluster.

In response to receiving the Subscribe from the mobile terminal 10 in T30, the printer 100 sends a Publish indicating that it provides the short-range printing service to the mobile terminal 10 in T32.

The mobile terminal 10 can find the printer 100 that provides the short-range printing service by receiving the Publish from the printer 100 in T32. In a case where the mobile terminal 10 finds multiple printers, including the printer 100, as printers providing the short-range printing service, the mobile terminal 10 may display a screen for selecting a printer to execute printing from among the multiple printers. Hereinafter, the description continues with the case where the printer that is to execute printing is the printer 100 as an example.

The mobile terminal 10 sends a ‘Ranging Request’ frame to the printer 100 in T34. The Ranging Request frame is a signal that requests a process for measuring a distance between the mobile terminal 10 and the printer 100 to be executed. The Ranging Request frame is also a signal communicated using a layer that is lower than the network layer of the OSI reference model.

In response to receiving the Ranging Request frame from the mobile terminal 10 in T34, the printer 100 sends a Ranging Response frame to the mobile terminal 10 in T36. The Ranging Response frame is also a signal communicated using a layer that is lower than the network layer of the OSI reference model. In T34 and T36, information necessary for communication in T40 described below (e.g., parameters for measurement) is communicated. That is, the communication of T34 and T36 is a preliminary communication for the communication of T40.

The mobile terminal 10 receives the Ranging Response frame from the printer 100 in T36. In this case, a Fine Timing Measurement (FTM) Sequence is executed between the mobile terminal 10 and the printer 100 in T40. FTM is a distance calculation algorithm employed in the Wi-Fi Aware scheme. The FTM Sequence is also communicated using a layer that is lower than the network layer of the OSI reference model.

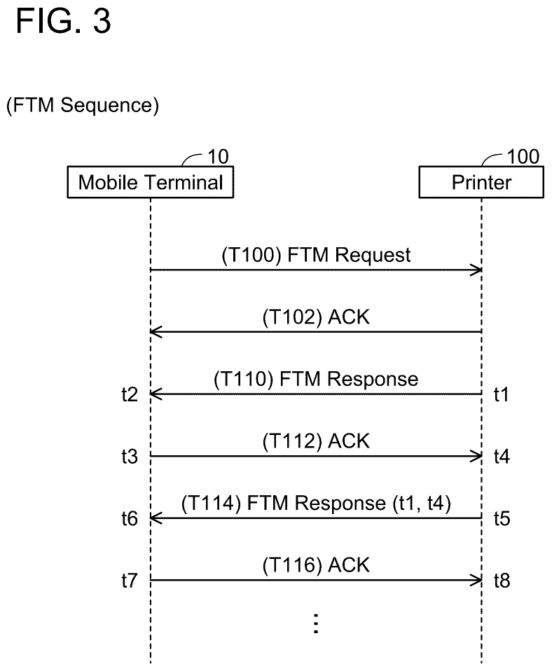

### (FTM Sequence: FIG. 3)

Referring now to FIG. 3, the FTM Sequence in T40 in FIG. 2 will be described. In T100, the mobile terminal 10 sends an FTM request to printer 100. The FTM request is a signal that requests the FTM to be started and includes, for example, information related to frequency bands used for various FTM communications.

In response to receiving the FTM request from the mobile terminal 10 in T100, the printer 100 sends an ACK to the mobile terminal 10 in T102. In response, the FTM is started from T110.

In the FTM, the printer 100 first sends an FTM response to the mobile terminal 10 in T110. At this time, the printer 100 stores a time t1 at which the FTM response was sent.

The mobile terminal 10 receives the FTM response from the printer 100 in T110. At this time, the mobile terminal 10 stores a time t2 at which the FTM response was received. The mobile terminal 10 then sends an ACK to the printer 100 in T112. At this time, the mobile terminal 10 stores a time t3 at which the ACK was sent.

The printer 100 receives the ACK from the mobile terminal 10 in T112. At this time, the printer 100 stores a time t4 at which the ACK was received.

The printer 100 then sends an FTM response to the mobile terminal 10 in T114. This FTM response includes the stored time t1 and time t4. Further, the printer 100 stores a time t5 at which the FTM response was sent in T114.

The terminal 10 receives the FTM response from the printer 100 in T114. At this time, the mobile terminal 10 stores a time t6 at which the FTM response was received.

The terminal 10 calculates the distance between the mobile terminal 10 and the printer 100 by using the stored times t2 and t3 and the times t1 and t4 included in the FTM response received in T114. Specifically, the mobile terminal 10 first calculates RTT1=(t4−t1)−(t3−t2). The RTT1 is the sum of a time period taken to send the FTM response of T110 and a time period taken to send the ACK of T112. That is, the RTT1 is a time period taken for one cycle of communication between the mobile terminal 10 and the printer 100. The terminal 10 then calculates the distance between the mobile terminal 10 and the printer 100 by a formula ((c×RTT1)/2), where c is light speed. Thus, the mobile terminal 10 can calculate the distance between the mobile terminal 10 and the printer 100 using the times t1 and t2 related to the communication of the FTM response and the times t3 and t4 related to the communication of the ACK.

In T116, the mobile terminal 10 sends an ACK to the printer 100. At this time, the mobile terminal 10 stores a time t7 at which the ACK was sent.

The printer 100 receives the ACK from the mobile terminal 10 in T116. At this time, the printer 100 stores a time t8 at which the ACK was received.

Thereafter, the mobile terminal 10 and the printer 100 repeat communicating an FTM response and an ACK predetermined times. The mobile terminal 10 calculates a distance between the mobile terminal 10 and the printer 100 for each cycle of communication of an FTM response and ACK. For example, for the FTM response of T114 and the ACK of T116, a distance between the mobile terminal 10 and the printer 100 is calculated by a formula ((c×RTT2)/2), where RTT2=(t8−t5)−(t7−t6).

### (Continuation of Processes: FIG. 2)

Returning to the description of FIG. 2, in T42, the mobile terminal 10 specifies the distance between the mobile terminal 10 and the printer 100 by calculating an average of the multiple distances calculated in the FTM Sequence in T40.

In T50, the mobile terminal 10 determines whether the distance specified in T40 is within 1 meter (1 m), which is a predetermined threshold value. Here, the threshold value of 1 m is an example and the threshold value may be less than 1 m or greater than 1 m. The threshold value is a distance shorter than a maximum distance within which it is possible to communicate with the printer 100 via the Wi-Fi interface 18 (e.g., 50 to 100 meters). However, the threshold value is preferably small to a certain degree. This is because if printing is executed by the printer 100 with the distance between the printer 100 and the mobile terminal 10 being large, the printed material may be seen by a third party. In a case where the specified distance is equal to or less than 1 m (YES to T50), the mobile terminal 10 proceeds to T70 without executing T52, T60, and T62. In a case where the specified distance is greater than 1 m (NO to T50), the mobile terminal 10 proceeds to T52.

In T52, the mobile terminal 10 displays a notification screen SC1 on the display unit 14 to prompt the user to bring the mobile terminal 10 closer to the printer 100 within 1 m of the printer 100. This allows the user to approach the printer 100 while carrying the mobile terminal 10.

Thereafter, in T60, an FTM Sequence is executed between the mobile terminal 10 and the printer 100. T60 is similar to T40 (i.e., the process in FIG. 3). Next, in T62, the mobile terminal 10 specifies the distance between the mobile terminal 10 and the printer 100 by calculating the average of the multiple distances calculated in T60. The mobile terminal 10 then returns to T50 to determine whether the distance specified in T60 is equal to or less than the predetermined threshold value of 1 m.

In T70, the mobile terminal 10 sends a ‘Ranging Termination’, a signal for terminating the FTM Sequence, to the printer 100. The Ranging Termination is also a signal communicated using a layer that is lower than the network layer of the OSI reference model.

The mobile terminal 10 sends a ‘Data Path’ Request to the printer 100 in T80, receives a ‘Data Path’ Response from the printer 100 in T82, and sends a ‘Data Path’ Confirm to the printer 100 in T84. These signals are also communicated using a layer that is lower than the network layer of the OSI reference model. The communication of these signals allows a connection to be established between the mobile terminal 10 and the printer 100. The mobile terminal 10 and the printer 100 belong to the same Wi-Fi network and can communicate using the network layer or higher layer of the OSI reference model.

The mobile terminal 10 converts the file to be printed, which was specified in T12, to print data, and in T90, the mobile terminal 10 sends the print data to the printer 100 using the Wi-Fi network formed in T80 to T84. The print data has a data format that the printer 100 can interpret. In this way, the mobile terminal 10 can properly send the print data to the printer 100 using the Wi-Fi network according to the Wi-Fi Aware scheme.

In response to receiving the print data from the mobile terminal 10 in T90, the printer 100 executes printing according to the print data in T92. Thus, the user can get a material printed by the printer 100.

### Effect of First Embodiment

According to the above configuration, the mobile terminal 10 specifies the distance calculated based on the communication of the FTM response (T110 in FIG. 3) and the ACK (T112) via the Wi-Fi interface 18 (T42, T62 in FIG. 2), and in the case where the distance is equal to or less than 1 m, the mobile terminal 10 sends the print data to the printer 100 (T90), and in the case where the distance is not equal to or less 1 m, the mobile terminal 10 does not send the print data to the printer 100. Thus, the mobile terminal 10 can switch whether or not to send the print data to the printer 100 depending on the distance calculated using a different method than the conventional methods.

### (Correspondence Relationships)

The mobile terminal 10 and the printer 100 are examples of “first communication device” and “second communication device”, respectively. The FTM response in T110 and the ACK in T112 in FIG. 3 are examples of “first signal” and “second signal,” respectively. The process in T90 is an example of “communication of predetermined data” and “predetermined process”. T40, T42, and T90 in FIG. 2 are examples of “receive a first signal from a second communication device via the Wi-Fi interface and send a second signal to the second communication device via the Wi-Fi interface”, “specify a first target distance”, and “execute a predetermined process”, respectively. T22 is an example of “join, via the Wi-Fi interface, a cluster”; T34 and T36 are examples of “execute preliminary communication”.

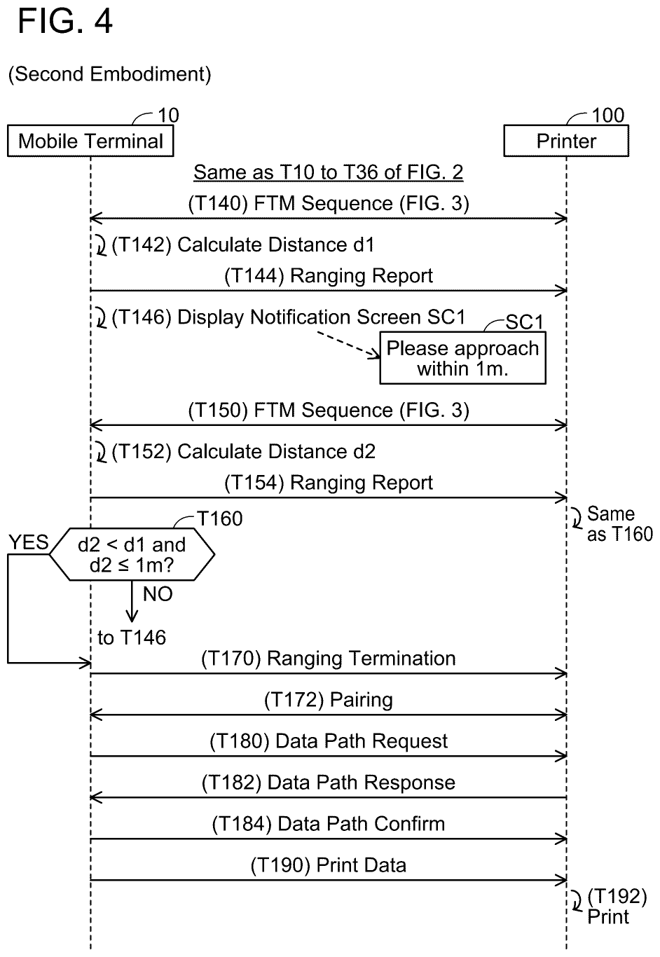

### Second Embodiment: FIG. 4

The second embodiment will be described with reference to FIG. 4. The present embodiment differs from the first embodiment in that the printer 100 also executes determination using a distance, and that pairing is performed between the mobile terminal 10 and the printer 100.

Processes the same as T10-T36 in FIG. 2 are executed. Next, in T140, an FTM Sequence is executed between the mobile terminal 10 and the printer 100. T140 is the same as T40 in FIG. 2 (i.e., FIG. 3). In T142, the mobile terminal 10 specifies a distance d1 between the mobile terminal 10 and the printer 100 by calculating an average of multiple distances calculated in T140.

In T144, the mobile terminal 10 sends a ‘Ranging Report’ including distance information indicating the distance d1 specified in T142 to the printer 100. This allows the printer 100 to know the distance d1. The Ranging Report is also a signal communicated using a layer that is lower than the network layer of the OSI reference model.

The mobile terminal 10 displays the notification screen SC1 on the display 14 in T146. This allows the user to approach the printer 100 while carrying the mobile terminal 10.

Thereafter, in T150, an FTM Sequence is executed between the mobile terminal 10 and the printer 100. T150 and the subsequent T152 and T154 are the same as T140 to T144, respectively. This allows the mobile terminal 10 to calculate a distance d2 and the printer 100 to know the distance d2.

In T160, the mobile terminal 10 determines whether the distance d2 is less than the distance d1 and whether the distance d2 is equal to or less than 1 m. That is, the mobile terminal 10 determines whether the user approached within 1 m of the printer 100 while carrying the mobile terminal 10 after the notification screen SC1 was displayed. In a case where the mobile terminal 10 determines that the distance d2 is less than the distance d1 and the distance d2 is equal to or less than 1 m (YES to T160), the mobile terminal 10 proceeds to T170. The mobile terminal 10 returns to T146 in a case where the mobile terminal 10 determines that the distance d2 is greater than distance d1 or in a case where the mobile terminal 10 determines that the distance d2 is greater than 1 m (NO to T160). This causes T150 to be executed again and the distance d2 is again specified. Then, based on the distance d2, the processes of T154 and T160 are executed again.

When the printer 100 receives the Ranging Report from the mobile terminal 10 in T154, the printer 100 executes the same determination as T160. In a case where the printer 100 determines that the distance d2 is less than the distance d1 and the distance d2 is equal to or less than 1 m, the printer 100 shifts to state for executing pairing as described below. In a case where the printer 100 determines that the distance d2 is equal to or greater than the distance d1 or in a case where the mobile terminal 10 determines that the distance d2 is greater than 1 m, the printer 100 does not shift to the state for executing the pairing.

T170 is the same as T70 in FIG. 2. Next, in T172, the pairing is executed between the mobile terminal 10 and the printer 100. This allows the mobile terminal 10 and the printer 100 to perform secure communication using authentication. The pairing is also communicated using a layer that is lower than the network layer of the OSI reference model. T180 to T192 are the same as T80 to T92 in FIG. 2.

### Effect of Second Embodiment

In this embodiment also, the mobile terminal 10 can also switch whether or not to send print data to the printer 100 depending on the distance calculated using a different method than the conventional methods. In particular, the mobile terminal 10 sends the print data to the printer 100 in the case where the user approaches the printer 100 while carrying the mobile terminal 10. For example, in a case where there are multiple printers including the printer 100, the user can have the printer 100 properly execute printing by approaching the printer 100 that is to execute printing.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) The “second communication device” is not limited to the printer 100, but may be another device such as a scanner, a multifunction device, a PC, a mobile terminal, etc. For example, in a case where the “second communication device” is a scanner, “communication of predetermined data” and “predetermined process” may be processes of communicating scan data. In a case where the “second communication device” is a PC, the “communication of predetermined data” and “predetermined process” may be a process of communicating data different from print data or scan data (e.g., document data, photo data).

The “predetermined process” is not limited to communication of print data between the mobile terminal 10 and the printer 100, but may be communication of other data as described in Modification 1 above, or may be a process different from communication between the mobile terminal 10 and the printer 100. Such different process may be, for example, a process of displaying a selection screen for selecting print condition(s). In this modification, sending of print data is an example of “communication of predetermined data” and the displaying of a selection screen is an example of “predetermined process”. Such different process described above may be, for example, a process of sending print data to a cloud server.

(Modification 3) In each of the above embodiments, the printer 100, instead of the mobile terminal 10, may calculate the distance. For example, instead of receiving the Ranging Request from the mobile terminal 10 in T34, the printer 100 sends the Ranging Request to the mobile terminal 10. In this case, the printer 100 receives the Ranging Response from the mobile terminal 10 in T36. Then, the printer 100 executes the processes of T40 and T42 and sends the Ranging Report including distance information indicating the calculated distance to the mobile terminal 10. In this modification, the mobile terminal 10 receiving the Ranging Report from the printer 100 and specifying the distance indicated by the distance information included in the Ranging Report is an example of the process executed by “specify a first target distance”. That is, “specify a first target distance” may not have to calculate the first target distance. In this modification, the FTM response is sent from the mobile terminal 10 to the printer 100 in T110 in FIG. 3, and the ACK is sent from the printer 100 to the mobile terminal 10 in T112. Therefore, the ACK and the FTM response are examples of “first signal” and “second signal,” respectively.

(Modification 4) The mobile terminal 10 may not have to repeatedly calculate the distance in the processes of FIG. 3. That is, when the mobile terminal 10 calculates the distance based on times t1 to t4, the mobile terminal 10 may use the distance to execute the determination of T50 in FIG. 2. In another modification, the mobile terminal 10 may calculate the distance using a time t10 at which the Ranging Request is sent to the printer 100 in T34 in FIG. 2 and a time t11 at which the Ranging Response is received from the printer 100 in T36. In this case, the distance is calculated by a formula ((c(t11−t10))/2), where c is the light speed. Generally speaking, “specify a first target distance” may not have to specify the first target distance, which is the average of multiple distances. In this modification, the Ranging Response and the Ranging Request are examples of “first signal” and “second signal,” respectively.

(Modification 5) The process of T146 in FIG. 4 can be omitted. In this case, for example, the user simply needs to be notified in an instruction manual of the printer 100 to approach the printer 100 within 1 m. In this modification, “cause the display to display a notification screen” can be omitted.

(Modification 6) The process of T172 in FIG. 4 can be omitted. In this modification, “execute pairing” can be omitted. In another modification, pairing may be executed between the mobile terminal 10 and the printer 100 in the first embodiment.

(Modification 7) The mobile terminal 10 may not have to execute the processes according to the Wi-Fi Aware scheme. That is, the mobile terminal 10 may search for the printer 100 existing around the mobile terminal 10 and execute the processes from T34 onward without executing T22 to T32 in FIG. 2. The mobile terminal 10 may also establish a Wi-Fi connection with the printer 100 using, for example, Wi-Fi Direct, SoftAP, or other methods without executing T80 to T84. In this modification, “execute preliminary communication” and “join, via the Wi-Fi interface, a cluster” can be omitted.

(Modification 8) In the above embodiments, the processes of steps in FIGS. 2 and 4 are realized by software (e.g., OS 36, app 42, program 140), but at least one of these processes may be realized by hardware such as a logic circuitry.

What is claimed is:

1. A first communication device comprising:
a Wi-Fi interface configured for Wi-Fi communication according to a Wi-Fi standard; and
a controller,
wherein the controller is configured to:
receive a first signal from a second communication device via the Wi-Fi interface and send a second signal to the second communication device via the Wi-Fi interface;
specify a first target distance between the first communication device and the second communication device, the first target distance being calculated based on communication of the first signal and the second signal;
in a case where the first target distance is equal to or less than a predetermined distance, execute a predetermined process related to communication of predetermined data between the first communication device and the second communication device, wherein in a case where the first target distance is not equal to or less than the predetermined distance, the predetermined process is not executed, and the predetermined distance is shorter than a distance in which the first communication device can communicate with the second communication device via the Wi-Fi interface.

2. The first communication device as in claim 1,
wherein the controller is configured to specify the first target distance by calculating the first target distance based on the communication of the first signal and the second signal.

3. The first communication device as in claim 2,
wherein the controller is configured to specify the first target distance, wherein the first targe distance is obtained by calculating a distance between the first communication device and the second communication device by using a time related to communication of the first signal and a time related to communication of the second signal and using the calculated distance.

4. The first communication device as in claim 3,
wherein the controller is configured to execute the communication of the first signal and the second signal multiple times, and
the controller is configured to, each time the communication of the first signal and the second signal is executed, calculate a distance between the first communication device and the second communication device based on the communication and specify the first target distance which is an average of the calculated multiple distances.

5. The first communication device as in claim 2,
wherein the controller is further configured to:
send distance information indicating the first target distance to the second communication device via the Wi-Fi interface.

6. The first communication device as in claim 1,
wherein the controller is further configured to:
before the communication of the first signal and the second signal is executed, receive a third signal from the second communication device via the Wi-Fi interface and send a fourth signal to the second communication device via the Wi-Fi interface; and
specify a second target distance between the first communication device and the second communication device, the second target distance being calculated based on communication of the third signal and the fourth signal,
wherein in a case where the first target distance is shorter than the second target distance and the first target distance is equal to or less than the predetermined distance, the controller is configured to execute the predetermined process, and
in a case where the first target distance is not shorter than the second target distance, the predetermined process is not executed.

7. The first communication device as in claim 6, further comprising a display,
wherein the controller is further configured to:
after the communication of the third signal and the fourth signal has been executed, cause the display to display a notification screen to prompt a user to move the first communication device closer to the second communication device.

8. The first communication device as in claim 1,
wherein the controller is further configured to:
in the case where the first target distance is equal to or less than the predetermined distance, execute pairing with the second communication device via the Wi-Fi interface,
wherein after the paring has been executed, the controller is configured to execute the predetermined process.

9. The first communication device as in claim 1,
wherein the controller is further configured to:
before the communication of the first signal and the second signal is executed, execute preliminary communication to execute the communication of the first signal and the second signal via the Wi-Fi interface.

10. The first communication device as in claim 1,
wherein the controller is further configured to:
before the communication of the first signal and the second signal is executed, join, via the Wi-Fi interface, a cluster to which the second communication device belongs.

11. The first communication device as in claim 1,
wherein the communication of the first signal and the second signal is communication according to a specific communication scheme of the Wi-Fi standard,
the first target distance is calculated by a distance calculation algorithm adopted by the specific communication scheme, and
the communication of the predetermined data is communication according to the specific communication scheme.

12. The first communication device as in claim 11,
wherein the specific communication scheme is Wi-Fi Aware.

13. The first communication device as in claim 1,
wherein the second communication device is capable of executing a print function, and
the predetermined process includes sending the predetermined data representing an image to be printed to the second communication device via the Wi-Fi interface.

14. A non-transitory computer-readable recording medium storing computer-readable instructions for a first communication device,
the first communication device comprises:
a Wi-Fi interface configured for Wi-Fi communication according to a Wi-Fi standard; and
a processor,
wherein the computer-readable instructions, when executed by the processor, cause the first communication device to:
receive a first signal from a second communication device via the Wi-Fi interface and send a second signal to the second communication device via the Wi-Fi interface;
specify a first target distance between the first communication device and the second communication device, the first target distance being calculated based on communication of the first signal and the second signal;
in a case where the first target distance is equal to or less than a predetermined distance, execute a predetermined process related to communication of predetermined data between the first communication device and the second communication device, wherein in a case where the first target distance is not equal to or less than the predetermined distance, the predetermined process is not executed, and the predetermined distance is shorter than a distance in which the first communication device can communicate with the second communication device via the Wi-Fi interface.

15. A method executed by a first communication device,
wherein the first communication device comprises a Wi-Fi interface configured for Wi-Fi communication according to a Wi-Fi standard,
the method comprising:
receiving a first signal from a second communication device via the Wi-Fi interface and sending a second signal to the second communication device via the Wi-Fi interface;
specifying a first target distance between the first communication device and the second communication device, the first target distance being calculated based on communication of the first signal and the second signal;
in a case where the first target distance is equal to or less than a predetermined distance, executing a predetermined process related to communication of predetermined data between the first communication device and the second communication device, wherein in a case where the first target distance is not equal to or less than the predetermined distance, the predetermined process is not executed, and the predetermined distance is shorter than a distance in which the first communication device can communicate with the second communication device via the Wi-Fi interface.
